(19) United States
(12) Patent Application Publication
(10) Pub. No.: US 2009/0188750 A1
(43) Pub. Date: Jul. 30, 2009

(54) Ladder Safety Device

(76) Inventor: Robert F. Charlton, Pullenvale (AU)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 12/277,260

(22) Filed: Nov. 24, 2008

(30) Foreign Application Priority Data
Nov. 23, 2007 (AU) 2007906403

(51) Int. Cl. E06C 7/48

(52) U.S. Cl. 182/107

(57) ABSTRACT

A ladder safety device is usable for holding and stabilizing a ladder in a safe and stable manner while being used, by way of securing a ladder relative to continuous horizontal guttering at the edge of a building. The device locks to the gutter by way of locking jaws and is secured to the side rail of a ladder by way of an adjustable locking bar.

### CROSS-REFERENCES TO RELATED APPLICATIONS

This application claims priority on prior filed Australian Provisional Application 2007906403, filed Nov. 23, 2007 and incorporates the same by reference in its entirety.

### FIELD OF THE INVENTION

This invention relates to an improved ladder safety device usable for holding a ladder in a safe and stable disposition while being used.

### BACKGROUND OF THE INVENTION

Many forms of apparatus and devices have been proposed in the past with a view to reducing accidents occasioned by lateral slippage of ladders placed so as to lean against buildings or other structures, especially against lengths of horizontal drainage guttering. A lengthy discussion on the danger factors is to be found in the specification of my International Patent Application No. PCT/AU02/00071 which is directly tied to the use of flexible connecting straps encircling ladder rungs and/or rails and having releasable engagement means securable where desired. Somewhat similar principles are illustrated in other patent specifications such as U.S. Pat. Nos. 4,924,971 to Rice and 4,545,460 to Byrd.

The present invention has been devised to provide a different approach to the problem of obtaining ladder stability, preferably without using flexible straps. Accordingly, its principal object is to provide a novel form of safety device which can be used more easily and positively than prior proposals, with low cost and simplicity, yet proving highly efficient in operation. Other objects and advantages of the invention will hereinafter be apparent.

### SUMMARY OF THE INVENTION

Throughout the specification, my safety devices are described by way of example in the principal application in securing a ladder relative to continuous horizontal guttering at the edge of a building. Such guttering typically has an inner web, a floor, and an outer web, the latter terminating in a roll-formed bead which may be of desired form such as circular, triangular or square in cross-section or simply flanged. The words “bead of the type described” are used herein to embrace any such structure against which the ladder may be placed regardless of design. If desired, it could be any rail type member, with or without conventional types of guttering. According to one aspect of the invention, there is provided a ladder safety device for stabilizing a ladder leaning against a horizontal bead of the type described, secured adjacent the edge of a building, said safety device including a portable, hand-held, jaw-mounting body having first and second jaw members adapted, when the device is inoperative, to be spaced from one another whereby the device may be brought to usage position and the body fitted over the bead so that the bead is accommodated between the two jaw members; actuating means associated with said body and adapted to be manually actuated to cause closing together of the jaw members and effect clamping of the bead relative thereto, and ladder securing means on the jaw-mounting body and adapted to be secured to the ladder to restrain relative motion between the ladder and the body when the device has been brought to usage position and said actuating means has been rendered operative.

In a preferred embodiment, the jaw-mounting body includes a lower body portion on which said first jaw member is mounted substantially fixedly but adapted to be adjustably set in selected position beneath and outwardly of said bead. Preferably also, the jaw-mounting body includes an upper body portion on which said second jaw member is mounted for pivotal movement about a horizontal axis between said raised inoperative positions spaced from the first jaw member and a lower clamping position in which it co-acts with the first jaw member and is disposed inwardly of said bead. Suitably, pivotal movement of the second jaw member is effected by a handle member pivotally connected thereto about a horizontal axis, the parts being so made and arranged that the handle is pivotally raised when the jaw members are spaced and inoperative but is swung down to a lower operative position adjacent the first jaw member when clamping is effected.

According to another preferred feature, locking means are provided to secure the second jaw member in its clamping position when the actuating means have been operated. Suitably, the locking means includes an over-center locking arrangement of the toggle locking type adapted to hold the jaw members effectively until the actuating means are released. In most instances, the jaw members are designed to effect clamping on opposite sides of an outer upwardly-extending gutter web having its top edge formed into said bead so that the web will be gripped closely below said bead.

According to another preferred feature, the jaw-mounting body constituted by two side-by-side portions joined about a vertical joint, the upper ends having pivot mountings for the pivoted second jaw member. Suitably, said vertical joint of the side-by-side body portions acts as a guide for a vertically adjustable mounting for the first jaw member. Suitably also, the first jaw member has a guide bolt passing through said vertical joint and spring-loaded so that it is digitally slidable to a selected vertical position. It is preferred that the co-acting faces of the two jaw members are each fitted with a hard rubber or similar elastomeric facing strip.

In a preferred embodiment, a quick-release trigger mechanism is provided for release of the actuating means when the latter is locked in a clamping position. Suitably, the quick-release trigger has at its lower end a locking lug engagable in said vertical joint in an aperture between said side-by-side portions.

In a similarly preferred embodiment, the ladder securing means includes a locking bar hinged to the jaw-mounting body and adapted to fit snugly there-against when not in use, but able to swivel and to be movable releasably to and around a side rail of a ladder located beside the device when the device is in use. Preferably, the locking bar is mounted for connection to a ladder at either side of the device when in use.

In an alternative preferred embodiment, the ladder securing means includes a locking bar which passes through holes on the top of the jaw-mounting body, being able to extend out via a controlled extension mechanism e.g. a spring activated locking device or a ratchet type mechanism, able to swivel around a side rail of a ladder located beside the device when the device is in use.

A further alternative improvement and preferred embodiment for securing the side rail of the ladder to the safety device is an extension of the ladder locking bar 47 so that the ladder locking device may be used to secure ladders on either side of the ladder in the one design by simply sliding such locking from side to side. This alternative improved design is purely an extension of the locking bar which passes through holes on the top jaw mounting body and being able to extend out either side via a controlled extension and locking mechanism, e.g. a spring activated or ratchet type mechanism, to prevent slippage of the locking bar and also to release the bar when required. This sliding bar mechanism allows for the side rail of the ladder to be fully stabilized against the side body of the ladder safety device.

Another major securing feature of the ladder safety device is that the ladder locking bar can be raised or lowered 49 to accommodate ladders of varying widths and at the same time securing such rails preventing any backward movement whilst in use by adjusting the locking bar down against the top side of the ladder rail. The locking bar raise and lower mechanism is spring loaded and is simply activated by a threaded micro-adjusting type wheelnut which is easily accessed at the mid top front of the ladder safety device.

As a further feature, the handle member for actuating the clamping jaw member is also designed for use in carrying the device between usage locations. Other features of the invention are hereinafter described.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order that the invention may be more readily understood and put into practical effect, reference will now be made to the accompanying drawings wherein:

FIG. 1 is a perspective view of a preferred embodiment of a ladder safety device according t o the present invention, shown attached to a ladder, and shown in a preliminary inoperative attitude prior to use.

FIG. 2 shows in side elevation the device illustrated in FIG. 1, again in the attitude prior to use.

FIG. 3 is a side elevation corresponding to FIG. 2 but with the actuating means operated so that the jaws are in clamping positions as in use.

FIG. 4 shows the components in the same attitudes as in FIG. 3, but as a perspective view similar to FIG. 1.

FIG. 5 is another perspective view similar to FIG. 4 but taken from the opposite side of the ladder and device.

FIG. 6 shows a front elevation of the alternative locking bar passing through holes on top of the jaw-mounting body.

FIG. 7 shows the adjustable mechanism for sliding bar and the micro-adjustment wheel.

FIG. 8 shows the ladder being secured by sliding bar against the safety device.

FIG. 9 shows the up and down adjustable bar securing the side rail of the ladder.

### DETAILED DESCRIPTION OF THE PREFERRED EMBODIMENTS OF THE INVENTION

With reference now to the drawings, the preferred embodiment of the ladder safety device is herein described. It should be noted that the articles “a”, “an”, and “the”, as used in this specification, include plural referents unless the content clearly dictates otherwise.

As shown in the drawings, the device indicated generally at 10 is for use in stabilizing a ladder 11 having horizontal rungs 12 and vertical rails 13. In this instance, the ladder 11 is leaning against a horizontal bead 14 of a gutter 15 at the edge of an outer upwardly-extending gutter web 16 integral with a gutter floor 17 and inner web 18 by which the gutter 15 is secured to a building (not shown).

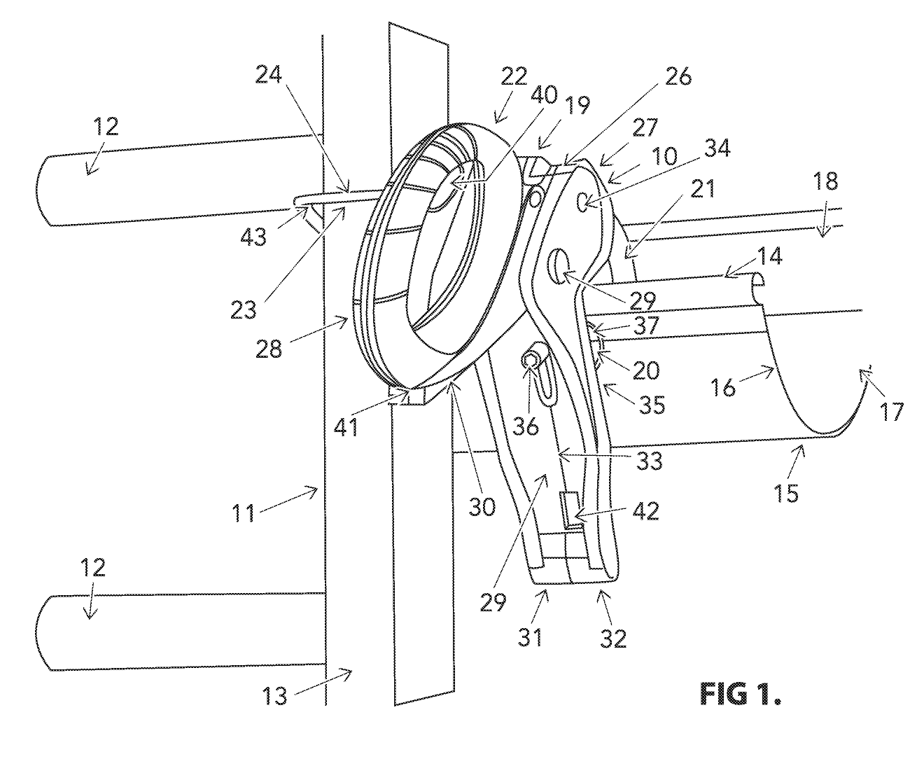

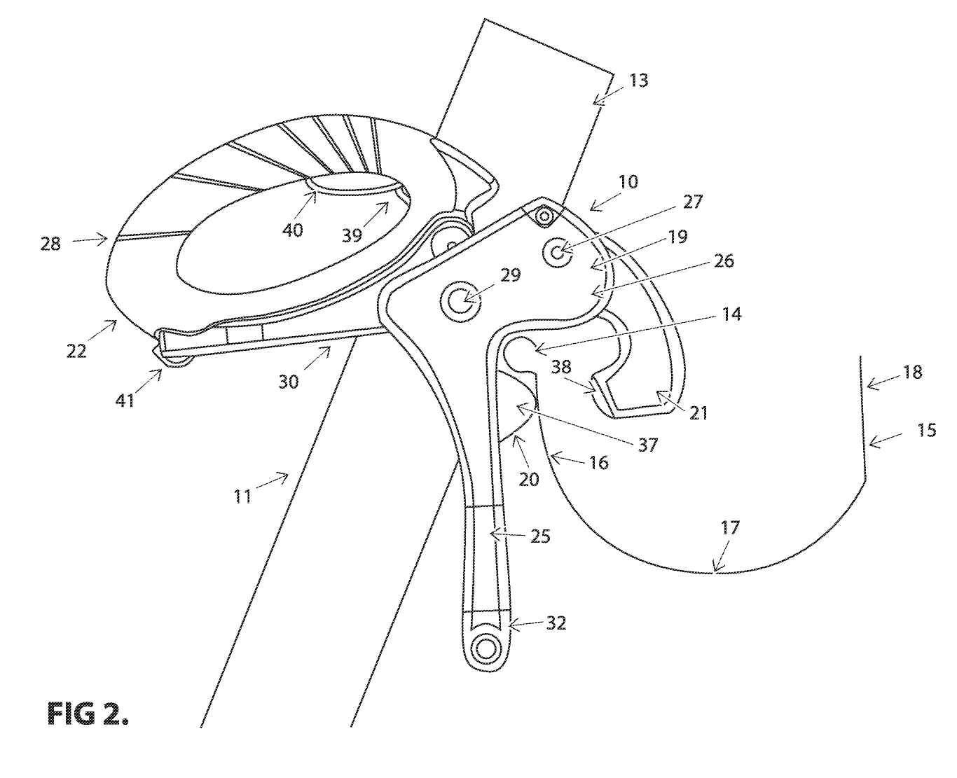

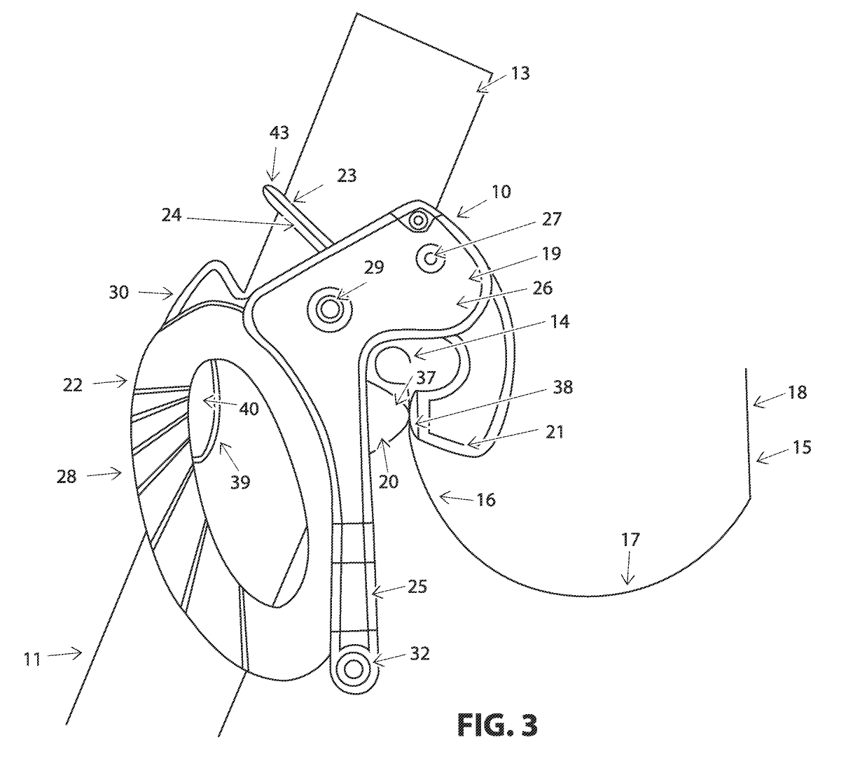

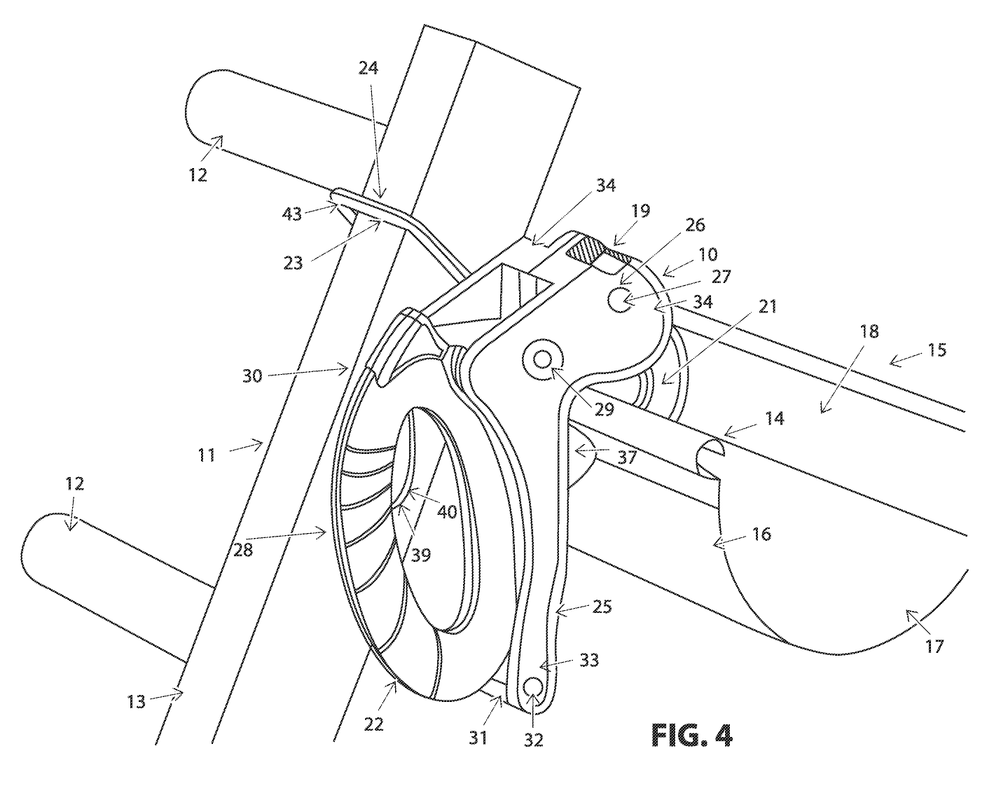

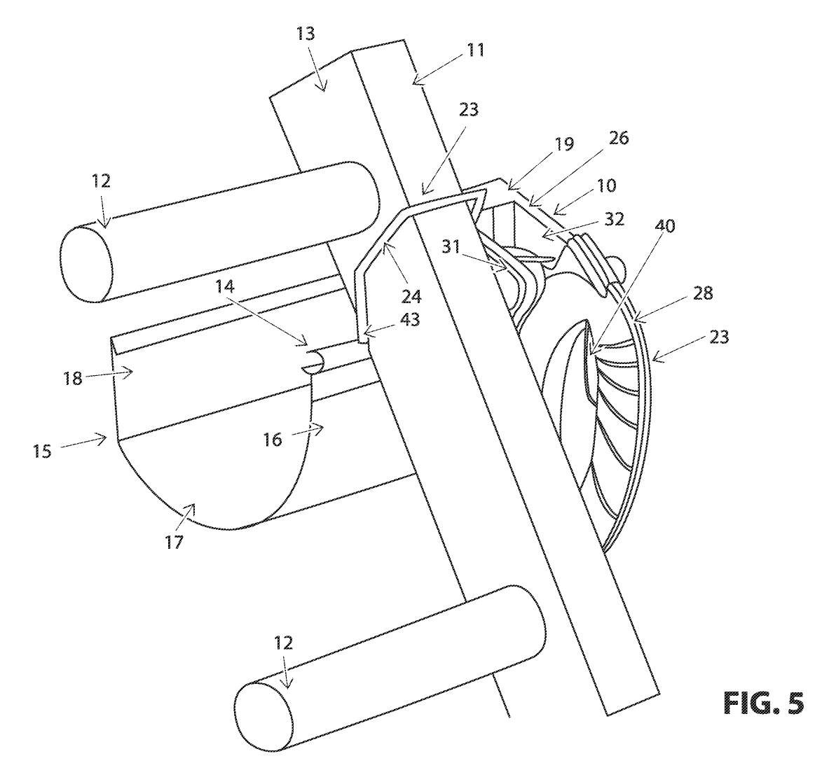

It will be seen that the device 10 includes a portable, hand-held, jaw-mounting body 19 having first and second jaw members 20 and 21 adapted, when the device is inoperative, to be spaced from one another as shown in FIGS. 1 and 2, whereby the device may be brought to usage position and the body 19 fitted over the bead 14 so that the bead is accommodated between the two jaw members 20 and 21 . Actuating means indicated generally at 22 are associated with said body 19 and are adapted to be manually actuated to cause closing together of the two jaw members 20 and 21 and effect clamping of the bead 14 relative thereto. Ladder securing means indicated generally at 23 is provided on the jaw-mounting body 19 and adapted t o be secured to the ladder 11 at 24 to restrain relative motion between the ladder and the body 19 when the device 10 has been brought to usage position and said actuating means 22 has been rendered operative as apparent from FIGS. 3 to 5.

It will be seen that the jaw-mounting body 19 includes a lower body portion 25 on which said first jaw member 20 is mounted substantially fixedly but adapted to be adjustably set in selected position beneath and outwardly of the bead 14 as best shown in FIG. 2. The jaw-mounting body 19 includes also an upper body portion 26 on which the second jaw member 21 is mounted for pivotal movement about a horizontal axis 27 between the raised, inoperative positions spaced from the first jaw member 20 and a lower clamping position as shown in FIG. 3 in which it co-acts with the first jaw member 20 and is disposed inwardly of the bead 14.

It will be seen that pivotal movement of the second jaw member 21 is effected by a handle member 28 pivotally connected thereto about a horizontal axis 29. By comparing FIGS. 2 and 3, it will be noted that the handle 28 is pivotally raised when the jaw members are spaced and inoperative but is swung down to a lower operative position adjacent to the first jaw member 20 when clamping is effected.

Locking means indicated generally at 30 is provided to secure the second jaw member 21 in its clamping position when the actuating means 22 have been operated. The locking means 30 includes linkages, pivots and levers between the handle 28 and second jaw 21 to provide an over-centre arrangement of the toggle-locking type adapted to hold the jaw members effective until the actuating means are released. The locking means includes a further pivot (not shown) between the upper components so that a “past dead center” toggle action can be obtained.

As shown in FIGS. 2 and 3, the jaw members 20 and 21 are designed to effect clamping on opposite sides of the outer, upwardly extending gutter web 16 which has the said bead 14 at its top. Most desirably, the web 16 will be gripped closely below said bead 14 as shown in FIG. 3.

The jaw-mounting body 19 will be seen to be constituted by two side by-side portions 31 and 32 joined about a vertical joint 33, the upper ends having pivot mountings 34 for the pivoted second jaw member 21. It will be seen from FIG. 1 that the vertical joint 33 of the side by-side body portions 31 and 32 acts as a guide for a vertically adjustable mounting 35 for the first jaw member 20. In this regard, the first jaw member 20 has a guide bolt 36 passing through said vertical joint 33 and spring-loaded (not shown) so that it is digitally slidable to selected vertical position. It will also be noted that the co-acting faces 37 and 38 of the two jaw members are fitted with facing strips suitably of hard rubber similar elastomeric material.

A feature of the invention is the provision of a quick-release trigger mechanism 39 for release of the actuating means 22 when the latter is locked in a clamping position. The quick-release trigger 40 will be seen to be connected by linkage on the handle 28 to a lower locking lug 41 of hooked form engagable in the vertical joint 33 in a shouldered aperture 42 defined between the side-by-side portions 31 and 32.

Also, the ladder-securing means 23 includes a locking bar 43 hinged to the jaw-mounting body 19 and fitting snugly against it when not in use, but able to swivel and to be movable releasably to and around the side rail 13 of the ladder 11 located beside the device when the device is in use. As a simple design feature, the locking bar 43 is mounted for connection to the ladder 11 when the device 10 is at either side thereof. As will be apparent, the handle member 28 for actuating the clamping jaw member 21 is also designed for use in carrying the device between usage locations.

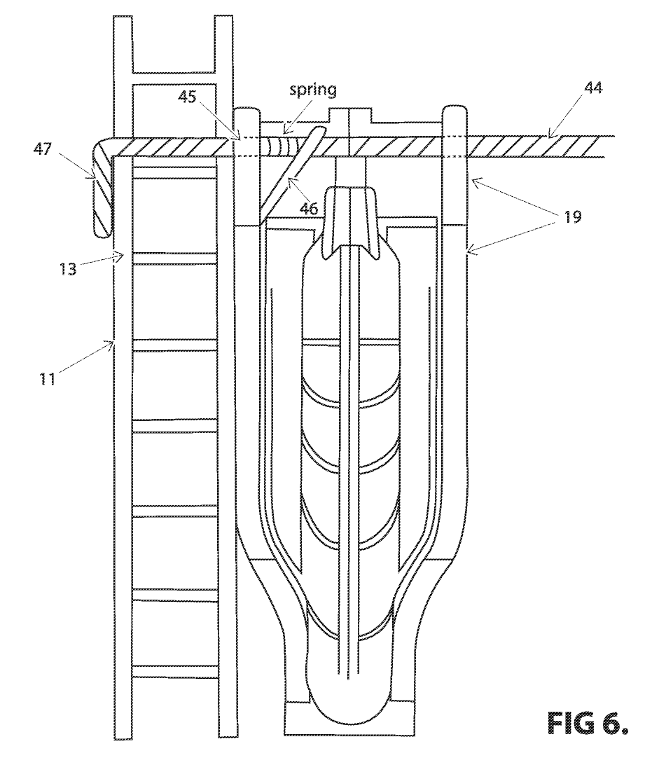

The ladder-securing means may also include an alternative locking bar structure 44 which passes through securing holes 45 on the top of the jaw-mounting body 19 (FIG. 6). There is a spring activated locking device 46, through which the locking bar 44 passes. When compressed this spring activated locking device 46 allows the locking bar 44 to slide through and extend or retract to the correct length to allow it to fit securely around the side rail 13 of the ladder 11. When the locking bar 47 fits snugly around the side rail of the ladder, the spring activated locking device 46 is released to lock the locking bar 44 in that position, thus locking the ladder against the device. The spring activated locking device 46 could also be replaced by a ratchet-type mechanism, which would utilize teeth in the locking bar 44, allowing the mechanism to lock the locking bar 44 in position at the required position.

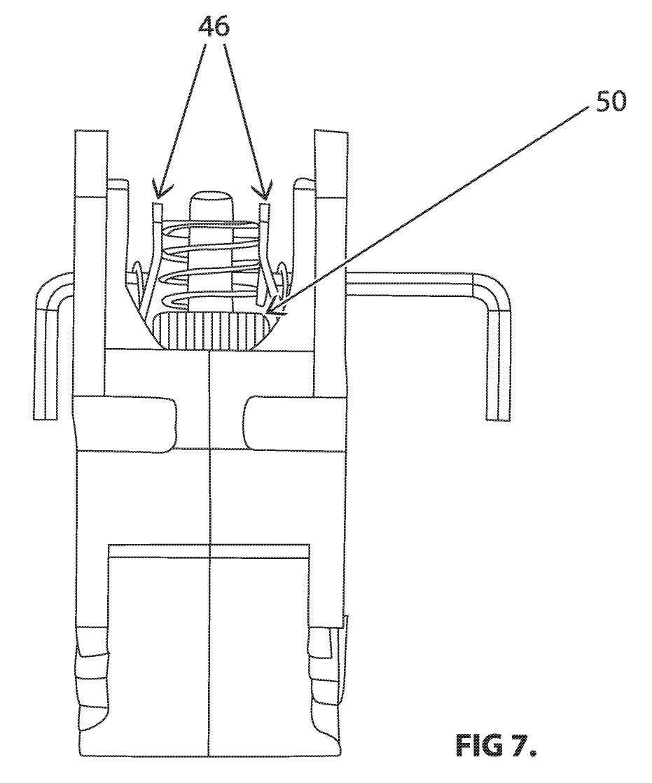

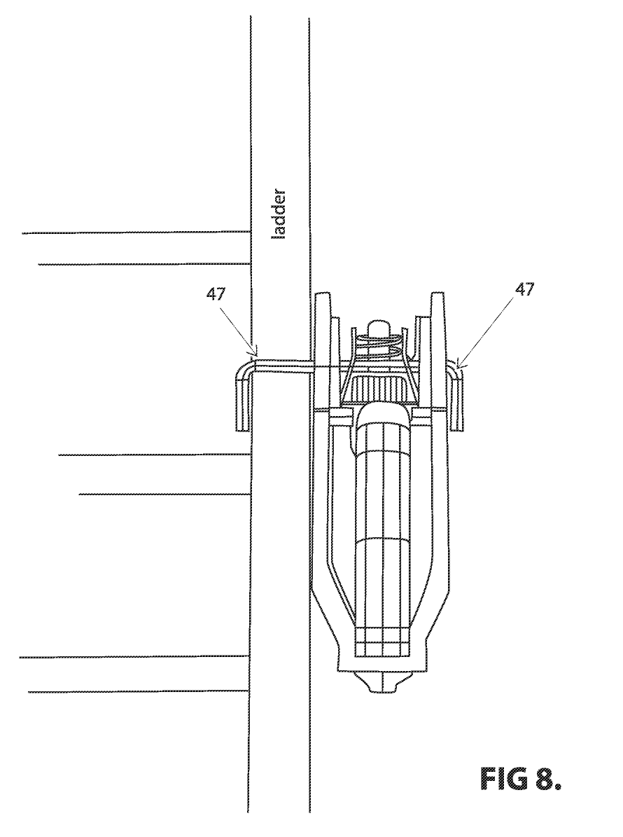

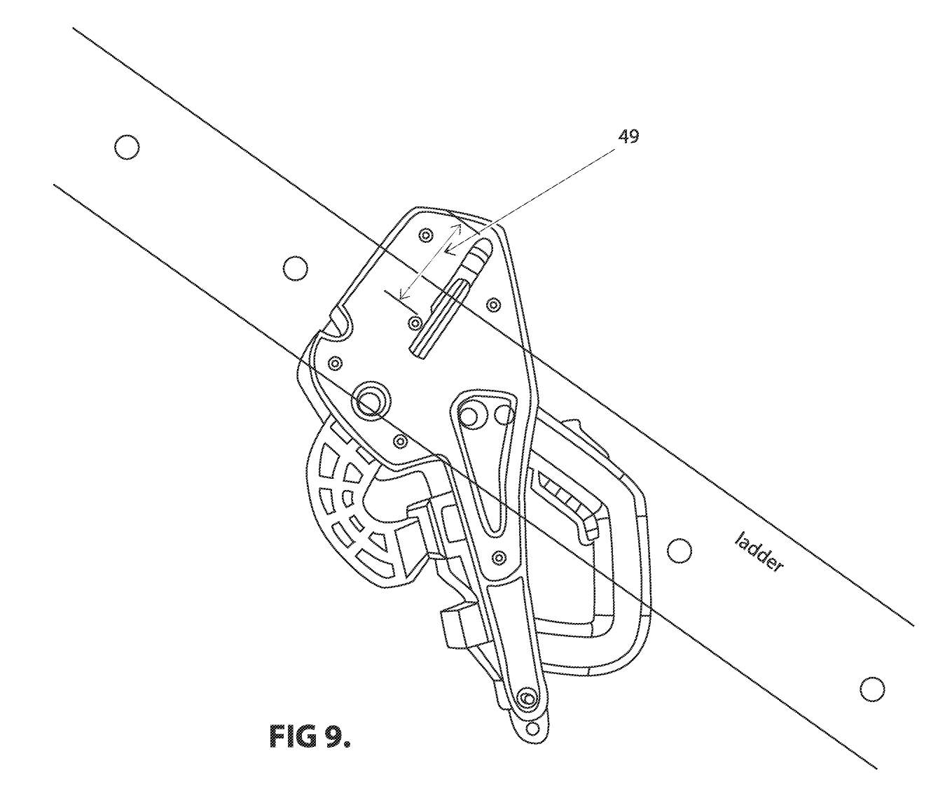

A further improvement to the mechanism is an adjustable locking bar 47, shown in FIG. 8. The locking bar 47 may slide to either side of the device and can then secure the ladder on either side of the safety device. The locking bar 47 may also be raised and lowered relative to the safety device (FIG. 9) and secured in position, thereby being able to be adjusted up or down to secure ladders of varying rail widths 49. The locking bar raise and lower mechanism is spring loaded 46 and is simply activated by threaded micro-adjusting wheel/nut 50 which is easily accessed at the mid top front of the ladder safety device, preventing the ladder side rail from moving backwards whilst in use (FIG. 7).

The manner of using the device 10 will be clear from the drawings and preceding descriptions but in any event is self evident. The device is light in weight and readily portable in a hand-held manner, and its compactness affords simple and safe movements at all times. The single handle is used initially for carrying the device, and then for putting it in the appropriate usage location over the bead, and then for effecting clamping and automatic locking in a past-dead-centre toggle action, similar to a louver window handle action. The locking bar is simple but effective, and the locking components have rigidity over an adequate length along the bead and guttering so that stability and safety are achieved.

While devices as described and illustrated will be found very effective in achieving the objects for which the invention has been devised, it will be understood that the embodiment described is illustrative only and may be subject to many modifications of constructional detail and design, as will be readily apparent to persons skilled in the art and without departing from the broad scope and ambit of the invention as defined by the appended claims.

I claim:

1. A ladder safety device for stabilizing a ladder leaning against a horizontal bead of the type described, secured adjacent the edge of a building, said safety device comprising:
a. a portable, hand-held, jaw-mounting body having first and second jaw members adapted, when the device is inoperative, to be spaced from one another whereby the device may be brought to usage position and the body fitted over the bead so that the bead is accommodated between the two jaw members;
b. actuating means associated with said body and adapted to be manually actuated to cause closing together of the jaw members and effect clamping of the bead relative thereto; and
c. ladder securing means on the jaw-mounting body and adapted to be secured to the ladder to restrain relative motion between the ladder and the body when the device has been brought to usage position and said actuating means has been rendered operative; said ladder securing means further comprising a locking bar both extensible and retractable in a lateral orientation with respect to the device, such that the locking bar has a range of motion capable that may extend to either a left or right side of the device.

2. The ladder safety device according to claim 1, wherein said jaw mounting body includes a lower body portion on which said first jaw member is mounted substantially fixedly but adapted to be adjustably set in selected position beneath and outwardly of said bead.

3. The ladder safety device according to claim 2, wherein said jaw-mounting body includes an upper body portion on which said second jaw member is mounted for pivotal movement about a horizontal axis between raised inoperative positions spaced from the first jaw member and a lower clamping position in which it co-acts with the first jaw member and is disposed inwardly of said bead.

4. The ladder safety device according to claim 3, wherein pivotal movement of the second jaw member is effected by a handle member pivotally connected thereto about a horizontal axis, the parts being so made and arranged that the handle is pivotally raised when the jaw members are spaced and inoperative but is swung down to a lower operative position adjacent the first jaw member when clamping is effected.

5. The ladder safety device according to either of claim 4, wherein locking means are provided to secure the second jaw member in its clamping position when the actuating means have been operated.

6. The ladder safety device according to claim 5, wherein the locking means includes an over-center locking arrangement of the toggle-locking type adapted to hold the jaw members effective until the actuating means are released.

7. The ladder safety device according to claim 6, wherein the jaw members are designed to effect clamping on opposite sides of an outer upwardly-extending gutter web having its top edge formed into said bead so that the web will be gripped closely below said bead.

8. The ladder safety device according to claim 6, wherein the jaw-mounting body is constituted by two side-by-side portions joined about a vertical joint, the upper ends having pivot mountings for the pivoted second jaw member.

9. The ladder safety device according to claim 8, wherein said vertical joint of the side-by-side body portions acts as a guide for a vertically adjustable mounting for the first jaw member.

10. The ladder safety device according to claim 9, wherein the first jaw member has a guide bolt passing through said vertical joint and spring-loaded so that it is digitally slidable to a selected vertical position.

11. The ladder safety device according to claim 8, wherein co-acting faces of the two jaw members are each fitted an elastomeric facing strip.

12. The ladder safety device according to claim 8, wherein a quick-release trigger mechanism is provided for release of the actuating means when the latter is locked in a clamping position.

13. The ladder safety device according to claim 12, wherein the quick-release trigger has at its lower end a locking lug engagable in said vertical joint in an aperture between said side-by-side portions.

14. The ladder safety device according to claim 4, the locking bar also being capable of motion in a vertical direction, normal to its range of motion.

15. The ladder safety device according to claim 14, further comprising a spring loaded mounting assembly for the locking bar, with means to adjust said assembly so as to control vertical positioning of the locking bar.

16. The ladder safety device according to claim 15, wherein the means to adjust said assembly comprising a rotatable adjustment wheel.

17. A ladder safety device according to claim 4 wherein the locking bar is positioned to allow for extension and retraction of the locking bar and is secured by way of an adjustment means for a secure connection and disconnection of the locking bar to and from the ladder, the adjustment means being chosen from the set of adjustment means consisting of a ratcheting assembly and a spring-loaded assembly.

18. A ladder safety device according to claim 4, wherein the handle member for actuating the clamping jaw member is also designed for use in carrying the device between usage locations.

19. A ladder safety device for stabilizing a ladder leaning against a horizontal bead of the type described, secured adjacent the edge of a building, said safety device comprising:
a. a portable, hand-held, jaw-mounting body having first and second jaw members adapted, when the device is inoperative, to be spaced from one another whereby the device may be brought to usage position and the body fitted over the bead so that the bead is accommodated between the two jaw members;
b. actuating means associated with said body and adapted to be manually actuated to cause closing together of the jaw members and effect clamping of the bead relative thereto; and
c. ladder securing means on the jaw-mounting body and adapted to be secured to the ladder to restrain relative motion between the ladder and the body when the device has been brought to usage position and said actuating means has been rendered operative; said ladder securing means further comprising a locking bar both extensible and retractable in a vertical orientation with respect to the device.

20. The ladder safety device according to claim 19, further comprising a spring loaded mounting assembly for the locking bar, with means to adjust said assembly so as to control vertical positioning of the locking bar.

21. The ladder safety device according to claim 20, wherein the means to adjust said assembly comprising a rotatable adjustment wheel.
